(19) United States
(12) Patent Application Publication
(10) Pub. No.: US 2013/0105411 A1
(43) Pub. Date: May 2, 2013

(54) Filter Module for Disposable Use, and a Method for Producing a Filter Module of This Type and the Use Thereof

(71) Applicant: Werner Loser, St. Gallen (CH)

(72) Inventor: Werner Loser, St. Gallen (CH)

(73) Assignee: FILTROX AG, St. Gallen (CH)

(21) Appl. No.: 13/809,712

(22) PCT Filed: May 31, 2011
(86) PCT No.: PCT/EP11/58897

§ 371 Date: Jan. 11, 2013

(30) Foreign Application Priority Data
Jul. 16, 2010 (EP) 10169860.3

(51) Int. Cl. B01D 29/41

(52) U.S. Cl. CPC B01D 29/41
USPC 210/777; 210/435; 210/323.1; 210/347

(57) ABSTRACT

A filter module (1) for disposable use with a closed and at least partially flexible, preferably expandable casing (3) as filter housing (2), a non-filtrate space (9) within the closed casing (3) and at least one first opening (10) through the casing (3) to the non-filtrate space (9), at least one second opening (8) for conducting the filtrate away through the casing (3) and one or more disc-like filtering elements (14) which are accommodated in the casing (3) and the interior of which is connected to the second opening (8), wherein a negative pressure in relation to the normal atmosphere of the surroundings prevails within the casing (3).

The present invention is in the field of filtration technology. It relates, in particular, to a filter module for disposable use, and to a method for producing a filter module of this type having the features of the preamble of the independent claims, and the use thereof.

In particular, in the chemical, pharmaceutical and biotechnological industries, in recent times a trend has developed such that all process steps are carried out in what are termed “disposables” or disposable products. As a result, the costly and complex cleaning is dispensed with, and also validation thereof and the risk of cross contamination is reduced. Filter modules for such applications can have, for example, a flexible casing which forms the filter housing. Filter modules for disposable use having a flexible casing are encountered, in particular, where a large filter surface area must be provided in order to maintain an acceptable flow rate. By using filter modules having flexing casings of usually low wall thickness, considerable material can be saved compared with filter modules having rigid casings.

For example, WO 2009/132864 A1 discloses such disposable filter modules. These filter modules have a flexible closed casing. In the casing, disk-shaped filter elements are arranged. In order to be able to use these filter modules at high pressure, the filter modules are introduced into a special positioning frame which defines the position, the orientation and the spatial size of the filter module. Since, for sealing the flexible casing, the casing must be produced to be significantly larger than necessary, introduction of the filter module into the positioning frame is associated with considerable difficulties. Thus, when introducing the filter module, for example, into a tubular positioning frame, the casing can shift relative to the filter elements, which in the worse case in operation under pressure can lead to a crack in the casing.

It is the object of the invention to overcome the disadvantages of the prior art. In particular, a filter module for disposable use is to be provided which can be manufactured simply and introduced without great effort into a corresponding positioning frame. In addition, safe operation should be ensured even under high pressure.

This object is achieved by the inventions defined in the independent claims. Further embodiments result from the dependent claims.

A filter module according to the invention for disposable use having a closed and at least partially flexible casing as filter housing comprises an unfiltrate space within the closed casing, and also one or more, in particular disk-shaped, filter elements accommodated in the casing. The casing comprises at least one first opening through the casing to the unfiltrate space (9) and at least one second opening for conducting away the filtrate through the casing. The filter elements are connected by their interior to the second opening. Within the closed casing, according to the invention a negative gauge pressure prevails in relation to the standard atmosphere of the surroundings. Of course, this negative gauge pressure is only present in the as-delivered state, or during installation of the filter module into a positioning frame, or before use or startup of the filter module. In particular, the negative gauge pressure is no longer present during the actual filtration process.

Negative gauge pressure in relation to the standard atmosphere of the surroundings is typically taken to mean a pressure which is less than 960 hPa. Preferably, the pressure is less than 900 hPa, particularly preferably less than 800 hPa. A pressure in the casing which is reduced in relation to the standard atmosphere ensures that the casing lies on the filter elements in the interior of the casing. The filter module can therefore be accommodated simply in a positioning frame without the casing shifting relative to the filter elements.

Clearly, such a negative gauge pressure can only be maintained if the casing and the openings are tightly closed or sealable. For this purpose, the openings can comprise special means such as, for example, valves and/or closure stoppers. Instead of valves or closure stoppers, the openings can also be firmly joined to connection lines which are tightly sealed. In order to be able to dispense with valves or closure stoppers, such connection lines can be, for example, welded tight. In addition, the casing is fabricated from air-tight material.

Flexible in this context is taken to mean that a component, similarly to a thin plastic film, can readily be bent and folded by hand, without breaking. A flexible casing may be folded and laid onto the filter elements without problem during nonuse of the filter module, in such a manner that the external dimension of the filter module corresponds to the external dimensions of the enclosed filter elements. At operating pressure and in a dimension-restricting positioning frame, the casing is folded up to the internal dimension of this frame.

The casing can be extensible, in such a manner that in operation it can optimally be adapted to the shape of a size-defining positioning frame. Even in the event of incorrect positioning of the casing or of the filter module in the positioning frame, this can ensure that the casing under pressure does not tear, but can expand correspondingly.

Extensible in the present case is taken to mean that the corresponding component may be extended under tension, that is to say its longitudinal extension changes. In this case the extension at break of the casing material is at least 10%, preferably at least 20% or more. An extensible casing may be extended uniformly independently of the shape thereof under pressure loading at the operating pressure and lays against, from the inside, a dimensionally-restricting positioning frame for receiving the filter module.

A flexible design can be achieved, for example, by a suitable material choice and/or by reduction of the wall thickness of the casing, which is beneficially expressed in the material consumption during production. Via a suitable choice of the materials, an extensible casing can even be achieved which can take up and compensate for, for example, pressure differences in the filtration arrangement. In this case the operating pressure for the filtration is 0 to 8 bar, preferably 0.1 to 2.5 bar. In the case of an extensible casing, the maximum extension must be restricted by a surrounding structure to a value below extension at break, preferably below the limit of elasticity. A cylindrical frame for accommodating a filter module having a flexible casing is dimensioned, for example, in such a manner that the internal diameter thereof is maximally 50%, preferably between 5% and 20%, greater than the diameter of the disk-shaped filter elements of the filter module. In this case the casing has a wall thickness from 10 μm to 1000 μm, preferably 100 μm to 500 μm, particularly preferably from 200 μm to 250 μm.

It has been found that the space in the interior of the casing is preferably evacuated in such a manner that the casing has a pressure of less than 900 hPa, particularly preferably less than 800 hPa. Via such a negative gauge pressure, for example, a user can simply verify that the casing is tight. At the same time, it is also simple to monitor whether a sterile filter is still sterile, which is advantageous, in particular in pharmaceutical applications.

Via the use of a plurality of filter elements in a shared casing, the flow rate can be increased at a constant filtration pressure.

The filter elements can be precoat filters, preferably combined with depth filters, and comprise a precoat space between the individual filter elements. This precoat space serves for building up a precoat filtercake during the precoat filtration.

Precoat filtration is substantially taken to mean a filter aid, for example kieselguhr, which forms a porous filter sheet, is floated onto a support material before or during the filtration. For this purpose, before the actual filtration, the filter aid can be introduced in a precoat phase using a separate fluid or with the fluid that is to be filtered. Optionally, the filter aid can be further introduced during the entire filtration together with the fluid that is to be filtered, in such a manner that the precoat filtercake constantly grows. This can prevent the porous filter sheet being plugged by dirt substances and as a result the flow rate decreasing.

These filter elements are spaced from one another and from the casing in such a manner that the precoat space of each filter element which surrounds the filter sheet in the direction towards the unfiltrate space as an encasing curve at a distance does not come into contact with the casing, another filter element or a precoat space of another filter element. This ensures that even in the case of a maximally built up precoat filtercake, the entire surface area of the filtercake is utilized and the flow rate through the filter module is not decreased. The distance of the encasing curve from the filter sheet which is at the same time the maximum thickness of the precoat filtercake or the precoat space is typically between 5 mm and 10 mm, in particular between 10 mm and 50 mm, and preferably between 15 mm and 25 mm. In order to ensure an optimal filtration output, between the precoat filtercakes among one another and to the enclosing casing, a free space of typically 1 mm to 10 mm, preferably from 1 mm to 5 mm, is constantly ensured. If the space falls below this value, and so the filtercakes touch one another, the flow rate decreases with a constant operating pressure and the filter elements can be deformed by an uneven pressure load. In order that the individual filter elements do not deform via their own weight in the case of a fully disassembled precoat cake, they can be fixed among one another, preferably via spacers arranged at the periphery.

The casing can consist of a plurality of plastic sheets, preferably of polyethylene (PE), polypropylene (PP), polyamide (PA), [ethylene vinyl alcohol]-copolymer (EVOH), polysulfone (PSU), polyethylene terephthalate (PET), ethylene vinyl acetate (EVA), polycarbonate (PC), polyvinylidene chloride (PVdC), polyolefin and/or polyvinyl chloride (PVC). The use of plastic as a material for the casing of the filter module permits particularly efficient production methods such as, for example, extrusion, deep-drawing, etc., which results in a cost reduction in the case of single use. Via a multilayer structure, material properties of different plastics can be combined. Apart from said materials, other materials or material combinations are likewise conceivable which are suitable as a result of particular material properties, such as environmental behavior during disposal, costs, weight, processability etc.

It has been found that the internal plastic sheet preferably consists of PE, since this material is characterized by a low water uptake and a high solvent resistance. An external sheet can consist, for example, of PA, in order to ensure greater strength.

The casing can be produced from two flat layers. Such flat layers can be simply joined around the edges to form a closed shape. For example, the layers can be welded. Welding in this context is understood to be equivalent to sealing. In this case, the flat layers can be joined in the shape of a polygon. Such shapes may be produced very simply by straight weld seams. Depending on the size and number of the filter elements, the two layers are preferably joined to form an octagon, for example roughly parallel to the planes of the filter elements, or to form a rectangle, for example roughly parallel to an axis through the filter elements. The casing can also be produced from a tubular film which is joined on both sides to form a closed shape. Such a shape reduces the number of weld seams required.

A method according to the invention for producing a filter module for disposable use comprises the steps:

a) providing one or more filter elements,

b) providing a pocket-type casing having at least one first opening for unfiltrate inlet and one second opening for filtrate outlet through the casing,

c) connecting the second opening to the interior of the filter elements,

d) introducing the filter elements into the pocket-type casing,

e) sealing the casing,

f) evacuating the casing, in particular via at least one of the openings,

g) sealing the openings required for the evacuation.

Steps c) and d) can be carried out in any desired sequence. Likewise, it is conceivable to evacuate the casing before sealing, if the evacuation is performed through a still unsealed side.

The use of a filter module according to the invention for precoat filtration offers a considerable saving in time when filling positioning frames, since the flexible casing lies against the filter elements during the filling and cannot shift relative to the filter elements. In particular in the case of applications which must satisfy increased purity requirements, for example in the chemical, pharmaceutical and biotechnological industries, known precoat filters can thus be used in a filtration system without the filter housing needing to be cleaned in a complex manner after the filtration operation, which in addition also makes superfluous the validation of a corresponding cleaning process. If the filter module is appropriately evacuated, the user can simply establish whether the filter module is isolated air-tightly and liquid-tightly from the surroundings. Contamination of the system by foreign matter can correspondingly be excluded.

With reference to figures which show merely exemplary embodiments, the invention will be described in more detail hereinafter. In the figures:

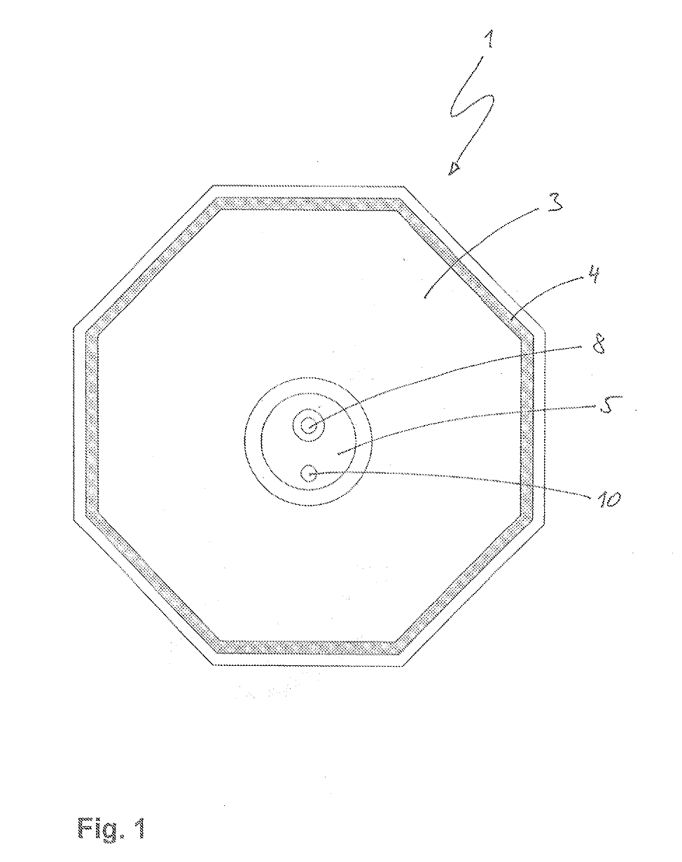

FIG. 1: shows a schematic depiction of an octagonally closed casing of a filter module according to the invention,

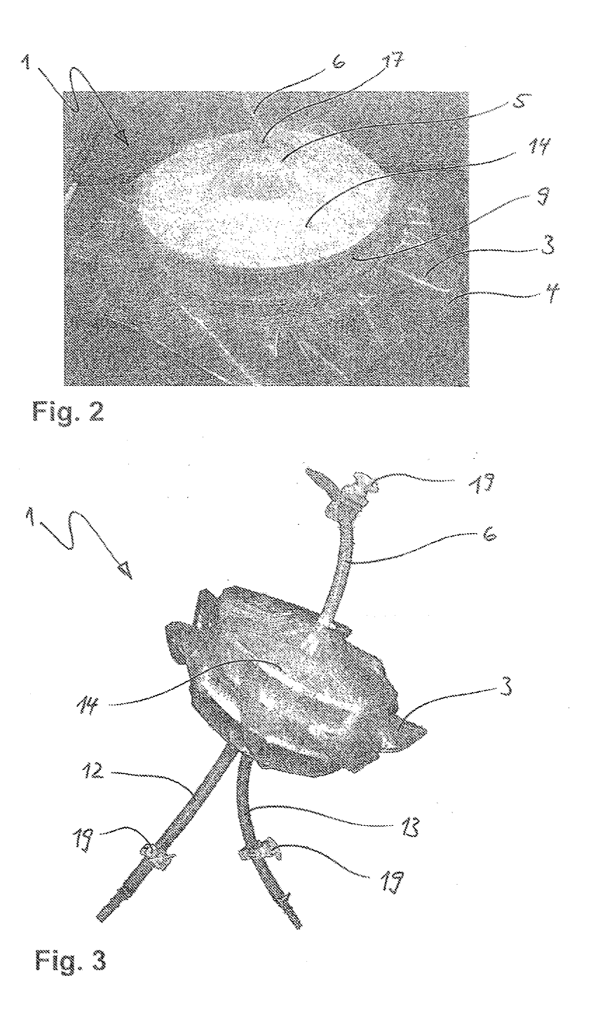

FIG. 2 shows a depiction of the filter module according to FIG. 1,

FIG. 3 shows the filter module according to FIG. 2 in the evacuated state,

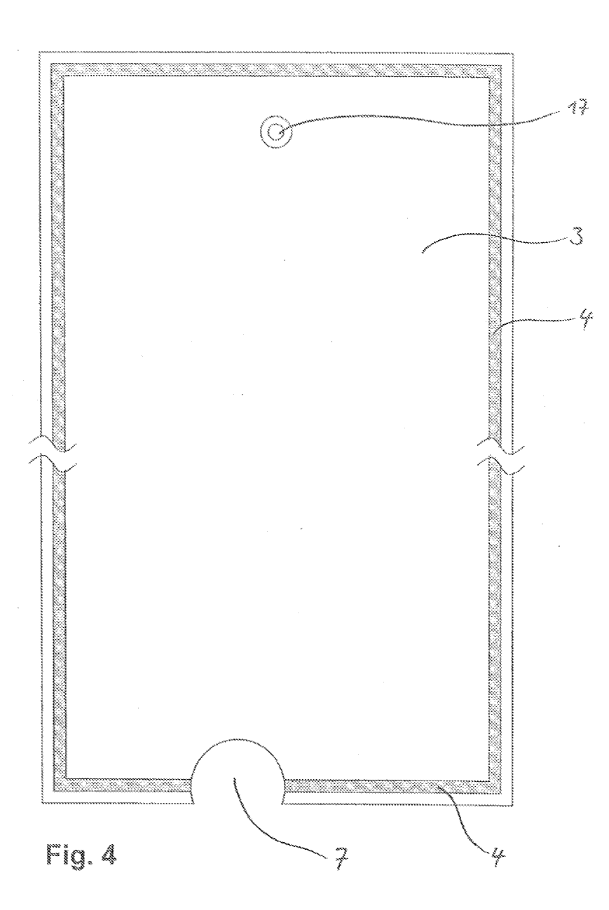

FIG. 4 shows a schematic depiction of a rectangularly closed casing of a filter module according to the invention,

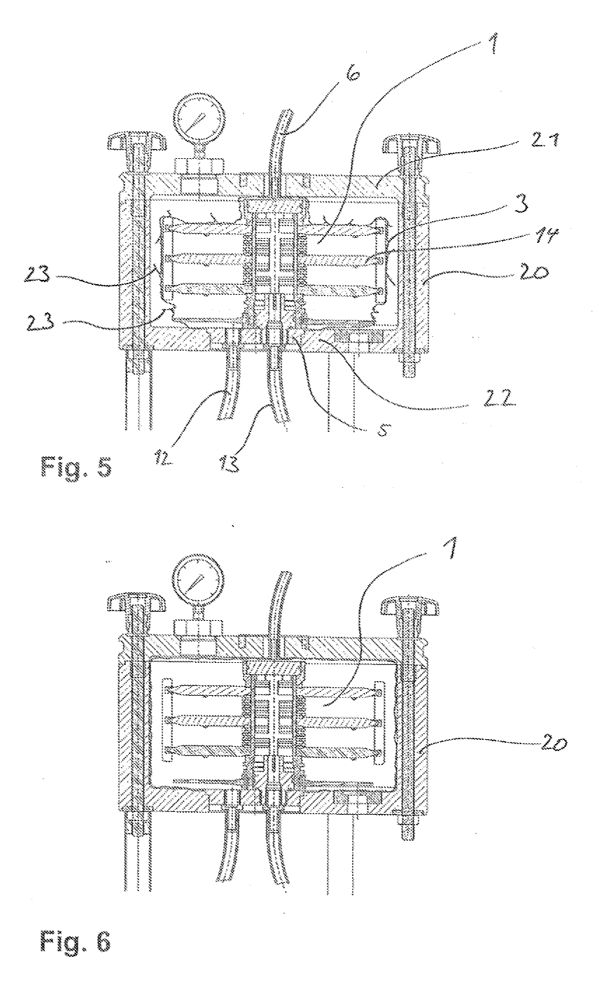

FIG. 5 shows a cross section through the evacuated filter module according to FIG. 2 installed in a positioning frame,

FIG. 6 shows the depiction according to FIG. 5, wherein the filter module is no longer evacuated, and the casing lies against the positioning frame,

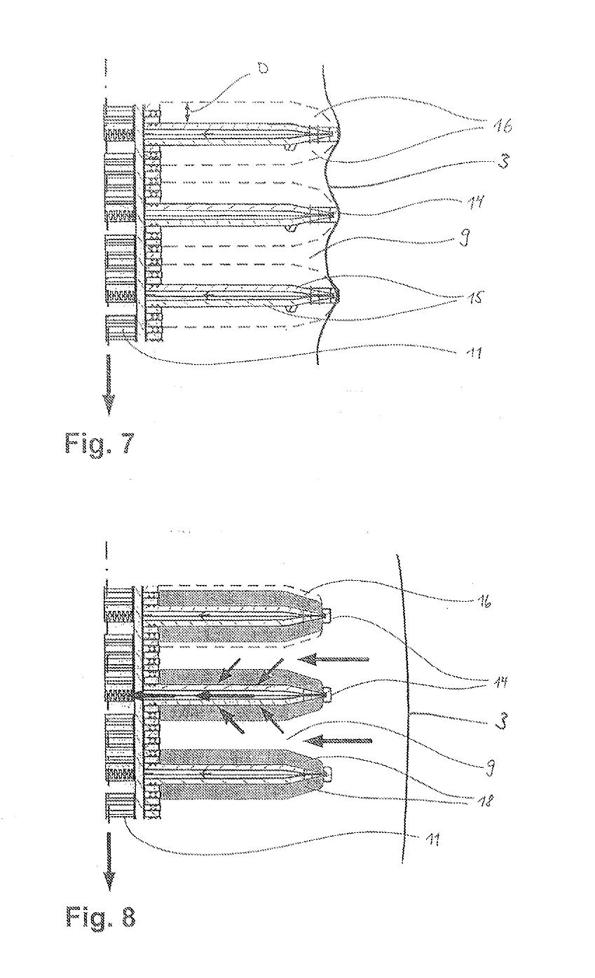

FIG. 7 shows a partial region of an evacuated filter module in cross section, and

FIG. 8 shows the partial region according to FIG. 5 of a filter module in use as intended.

FIG. 1 shows a schematic depiction of an octagonally closed casing 3 of a filter module 1 according to the invention. The casing 3 consists of two flat layers of a plastic material. In this case the two layers are joined by a weld seam 4 around the edges. Roughly centrally, a connection element 5 is arranged. This connection element 5 serves for positioning the filter module 1 in a positioning frame. In addition, the connection element 5 contains the openings 8, 10 for unfiltrate inlet and for filtrate outlet. Optionally, on the opposite side, an additional opening can be provided for venting the unfiltrate space. The filter elements, which are arranged in the interior of the casing 3, are not shown.

In FIG. 2, the filter module 1 from FIG. 1 is shown in perspective view. The casing 3 in this case is constructed so as to be transparent which is not obligatory, however. Around the edges, again, the weld seam 4 may be recognized. The connection element 5 is provided with a tube 6 which is connected to the venting opening 17 to the unfiltrate space 9. This tube 6 serves substantially for venting the unfiltrate space 9. The openings 8 and 10 (see FIG. 1) for the unfiltrate inlet and filtrate outlet, respectively, cannot be seen. In the interior of the casing 3, in the unfiltrate space 9, three filter elements 14 are arranged, are stacked and connected to one another. These filter elements 14 on both sides each have a precoat space 16 (see FIG. 5). The casing consists of a two-sheet plastic of thickness 250 μm. In this case the internal layer consists of a PE and the external layer of PA. Since the filter module 1 shown has only three filter elements 14, it is advantageous if the casing 3, as shown, is welded from two layers, which are arranged roughly parallel to the planes of the filter elements 14. For producing a filter module having a greater number of filter elements, a casing as shown in FIG. 4 is more suitable.

FIG. 3 shows the filter module according to FIG. 2 in the evacuated state. The pressure in the interior of the filter module is 800 hPa. It can clearly be seen how the casing 3 lies against the filter elements 14. Should the casing 3, against expectation, be damaged before insertion into a positioning frame, this is easily recognizable by a user, since the casing 3 then no longer lies against the filter elements 14. A situation then arrives as may be seen in FIG. 2. The tubes 12 and 13 for the unfiltrate inlet and the unfiltrate outlet may additionally be recognized, which are connected to the corresponding openings. Each of the three tubes, 6, 12, 13 is provided with a valve 19 which permits tight clamping off of the tube.

FIG. 4 shows a schematic depiction of a rectangularly closed casing 3 of a filter module 1 according to the invention. The weld seam 4 is again constructed around the edges and connects the two flat plastic layers. An opening 17 is let into the casing 3. For a connection element (which is not shown), a recess 7 is provided, into which the connection element is introduced and can be tightly connected. Such a connection element then has again two openings for the unfiltrate inlet and for the filtrate outlet. In such a casing 3, preferably the filter elements are arranged in such a manner that an axis passes through the filter elements roughly parallel to the longer side of the rectangularly closed casing 3.

FIG. 5 shows a cross section through the evacuated filter module 1 according to FIG. 2, installed in a positioning frame 20. In may clearly be seen that the casing 3 lies against the filter elements 14. The casing in this case forms folds 23 which, however, do not hinder the installation. The positioning frame 20 is clearly constructed so as to be greater than the filter elements 14 would require. In addition, the positioning frame 20 has a closing lid 21 and a base 22. For introducing the filter module 1, the closing lid 21 can be removed and thereby the positioning frame 20 opened. The filter module 1 is introduced into the positioning frame 21 in such a manner that the connection element 5 is seated together with the two tubes 12 and 13 in a recess of the base 22 and the tubes 12, 13 are thus freely accessible from the outside. When the positioning frame 20 is closed, the tube 6 is conducted through an opening in the closing lid 21, and so the tube 6 is also accessible from the outside.

In FIG. 6, the situation is shown when the filter module 1 is no longer evacuated. The casing 3 then lies against the positioning frame 20, wherein the folds 23 (see FIG. 5) have for the most part been relaxed.

In FIGS. 7 and 8, a partial region of a filter module is shown in cross section. In this case, in FIG. 7, the filter module is shown in the evacuated state and the filter elements 14 are shown without precoat filtercakes. The casing 3 lies against the filter elements 14 and is even drawn in part into the unfiltrate space 9. FIG. 8, in contrast, shows the filter module in use as directed during the filtration with a built up precoat filter cake 18. The casing 3 in this case is unfolded and lies against the positioning frame (which is not shown). The precoat space 16 in FIG. 5 is shown by the dashed line. The filter elements 14 are spaced apart from one another and the casing in such a manner that the precoat space 16 of each filter element 14 which surrounds the filter sheet 15 in the direction towards the unfiltrate space 9 as an encasing curve at a distance D no longer comes into contact with the casing, another filter element 14 or a precoat space 16 of another filter element 14. This maximum distance D between filter sheet 15 and encasing curve, or this maximum thickness of the precoat filtercake 18, is 20 mm in the exemplary embodiment shown, but, depending on the application, can also be dimensioned differently. Ideally, the intermediate space between two adjacent, completely precoated filtercakes 18 is between 1 mm and 5 mm. The flow of the unfiltrate that is to be filtered is shown by the arrows in FIG. 8. The unfiltrate exits from the unfiltrate space 9 through the precoat filtercake 18 into the filter element 14 and is conducted in the interior of the filter element 14 to the filtrate outlet line 11. The filtrate from the individual filter elements 14 is collected in the filtrate outlet line 11 and conducted to the corresponding opening. The filter elements 14 have on both sides a precoated filtercake 18.

1-14. (canceled)

15. A filter module for disposable use having a closed and at least partially flexible casing as filter housing, an unfiltrate space within the closed casing and at least one first opening through the casing to the unfiltrate space, at least one second opening for conducting away the filtrate through the casing and one or more filter elements accommodated in the casing, the interior of these filter elements is connected to the second opening, wherein a negative gauge pressure in relation to the standard atmosphere of the surroundings prevails within the closed casing.

16. The filter module as claimed in claim 15, wherein the casing is tightly closed or is sealable and consists of an air-tight material.

17. The filter module as claimed in claim 15, wherein the openings have means such that they are tightly closed or sealable.

18. The filter module as claimed in claim 15, wherein the filter elements are precoat filters and comprise a precoat space for building up a precoat filtercake between the individual filter elements.

19. The filter module as claimed in claim 18, wherein the filter elements are spaced from one another and from the casing in such a manner that the precoat space of each filter element which surrounds the filter sheet in the direction towards the unfiltrate space as an encasing curve at a distance does not come into contact with the casing, another filter element or a precoat space of another filter element.

20. The filter module as claimed in claim 19, wherein the distance is between 5 mm and 100 mm.

21. The filter module as claimed in claim 15, wherein the casing comprises a plurality of plastic sheets.

22. The filter module as claimed in claim 21, wherein the innermost plastic sheet consists of PE.

23. The filter module as claimed in claim 21, wherein the outermost plastic sheet consists of PA.

24. The filter module as claimed in claim 15, wherein the casing is produced from two flat layers which are joined around the edge to form a closed shape.

25. The filter module as claimed in claim 24, wherein the flat layers are joined in the shape of a polygon.

26. The filter module as claimed in claim 15, wherein the casing is produced from a tubular film which is joined on both sides to form a closed shape.

27. A method for producing a filter module for disposable use comprising the steps:
providing one or more filter elements,
providing a pocket-type casing having at least one first opening and one second opening through the casing,
connecting the second opening to the interior of the filter elements,
introducing the filter elements into the pocket-type casing,
sealing the casing,
evacuating the casing, in particular via at least one of the openings,
sealing the openings required for the evacuation.

28. A method for precoat filtering of an unfiltrate using a filter module as claimed in claim 15.
